(19) United States
(12) Patent Application Publication
(10) Pub. No.: US 2006/0031466 A1
(43) Pub. Date: Feb. 9, 2006

(54) Measuring responses incurred in network transactions

(75) Inventor: Roger P. Kovach, Bolinas, CA (US)

Correspondence Address: MICHAEL B. EINSCHLAG, ESQ., 25680 FERNHILL DRIVE, LOS ALTOS HILLS, CA, 94024, US

(73) Assignee: Applied Expert Systems, Inc., Menlo Park, CA (US)

(21) Appl. No.: 10/854,752

(22) Filed: May 26, 2004

(51) Int. Cl. G06F 15/173; G06F 15/16

(52) U.S. Cl. 709/224; 709/219

(57) ABSTRACT

One embodiment of the present invention is a method for measuring responses incurred in network transactions that include one or more transaction steps including: (a) identifying browser events and setting timers use to determine navigation times and document download times; (b) periodically testing browser status to determine browser idle times; and (c) determining end-to-end response times and response times for the one or more transaction steps from the navigation times, and document download times.

### TECHNICAL FIELD OF THE INVENTION

One or more embodiments of the present invention relate generally to transactions on a network such as, for example, and without limitation, the world wide web, the Internet, an intranet, a local area network, a wide area network, combinations of these transmission media, equivalents of these transmission media, and so forth.

### BACKGROUND OF THE INVENTION

eBusiness is a vital component of corporate success in today's global economy, and a slow Web site is a fast way to lose money. Overall Web site performance and availability can either attract users or frustrate them. The difference lies in an ability to maintain consistent, reliable Web site performance despite ever-increasing demands of innovation, performance, and complexity.

More often than not, many separate user interactions are required to be performed to carry out a single network transaction. For example, such network transactions may require entry of passwords, dealing with frames, and navigating through multiple page downloads. As such, in order to assess Web site performance accurately, it is useful to measure response incurred during an entire transaction, i.e., from end to end.

In a typical enterprise there are a number of functional areas that relate to, or are concerned with, performance characteristics of, among other things, page downloads and/or transaction up- and down-loads from a network such as the Internet. Such functional areas include, for example and without limitation: (a) procedure and process flow (including design, implementation, and administration); (b) web page use (including design, and installation); (c) network management (including design, implementation and administration); (d) application design and implementation; and (e) data and database management (including content, design, implementation, and administration). Before any of these functional areas can address unsatisfactory performance in page downloads, they must be: (a) notified that a problem exists; and, where possible, (b) provided some indication of the functional areas most likely to be involved. Ideally, such notification ought to be provided before there is a perception by users of unsatisfactory performance.

Prior art systems and methods for dealing with such issues tend to address only portions of the possible causes of performance deterioration—typically concentrating on networking and, to a lesser extent, on server behavior. In particular, page design and content performance characteristics are either not addressed, or require separate facilities. Specifically, data gathering is typically done by special devices, hardware or software, which typically operate at lower “International Standards Organization-Open Systems Interconnect” (ISO-OSI) layers planted at specific locations in the network. Further, some of them are expensive, cumbersome, and difficult to maintain.

In addition, if such a prior art system provides end-to-end response time; it typically provides few or no constituent times. In further addition, no such prior art system measures browser wait time or provides content identification (for example, and without limitation, a picture, a banner, an ad, and so forth), size measurements (for example, and without limitation, file or picture size), download times, or individual measurements for frames and/or pop-ups.

Most such prior art systems employ “agents,” i.e., blocks of software sent to a client computer by a central server, which emulate functions normally performed by a browser which allow certain start and end events and their times to be marked. In addition, some such prior art systems artificially invoke hardware and software components (for example, and without limitation, by issuing an http//get), such as a browser, to obtain typical “turnaround times” rather than recapitulating actual page up- and down-loads involved in a transaction, and some such prior art systems substitute for some or all of the components in the client computer to time the performance of network and server systems.

The above mentioned methods are taken from the client side which is the only way to accurately recapitulate the user's experience. Server side systems have been around for some time and are recognized as deficient. They also cannot emulate a complex serial interaction (or “transaction”).

In light of the above, there is a need for system and method to overcome one or more of the above-identified problems.

### SUMMARY OF THE INVENTION

One or more embodiments of the present invention are a method that overcomes one or more of the above-identified problems. In particular, one embodiment of the present invention is a method for measuring responses incurred in network transactions that include one or more transaction steps comprising: (a) identifying browser events and setting timers used to determine navigation times and document download times; (b) periodically testing browser status to determine browser idle times; and (c) determining end-to-end response times and response times for the one or more transaction steps from the navigation times, and document download times.

### BRIEF DESCRIPTION OF THE DRAWING

FIG. 1 shows a sequence of events and actions that take place as a transaction step is carried out (for example, as a page is downloaded from the Internet) by an application that is fabricated in accordance with one or more embodiments of the present invention;

FIG. 2 shows, in block diagram form, components of an application that is fabricated in accordance with one or more embodiments of the present invention, and how the components exchange data and control in downloading a page from the Internet and measuring response times;

FIG. 3 shows a sample transaction, and identifies components involved in network transaction time measurement in accordance with one or more embodiments of the present invention;

FIG. 4A shows a representation of a main or home page of Yahoo (“Yahoo home page”), FIG. 4B shows a page that is downloaded after clicking a “Games” link on the Yahoo home page, and FIG. 4C shows a page that is downloaded after clicking a “Tournaments” link on the Games page;

FIGS. 5A-5D show an excerpt of HTML code for the Yahoo home page shown in FIG. 4A, and FIGS. 5E-5G show an excerpt of HTML code for the Yahoo Games page shown in FIG. 4B which is reached from the Yahoo home page;

FIG. 6A shows a scripting page that may be used to enter information used to configure one step of a network transaction (i.e., to identify an appropriate element to click to cause a download of a “Games” page), and FIG. 6B shows a scripting page that may be used to enter data to configure a second step of the network transaction (i.e., to identify an appropriate element to click to cause a download of a “Tournaments” page); and

FIGS. 7A-7D show reports of response times of: (a) an entire transaction download; (b) each page downloaded; and (c) each interior download within each page download.

### DETAILED DESCRIPTION

One or more embodiments of the present invention are software applications for measuring response times, including an end-to-end response time, incurred while carrying out transactions on a network such as, for example, and without limitation, the world wide web, the Internet, an intranet, a local area network, a wide area network, combinations of these transmission media, equivalents of these transmission media, and so forth. As used herein, the term network transaction refers to carrying out a sequence of network interactions (sometimes referred herein as steps or sequence steps). Such interactions may include, for example and without limitation, entry of passwords, dealing with frames and pop-ups, and navigating through multiple page downloads.

In its most general sense, an application that is fabricated in accordance with one or more embodiments of the present invention emulates an interactive network transaction, and measures its performance in a manner that will be described in detail below. In particular, such interactive network transactions are stored in a Transaction database, and the application accesses the Transaction database, carries out the transactions stored therein, measures the response times, and stores the response times and other data (to be described in detail below) in a Results database.

In accordance with one or more embodiments of the present invention, the Transaction database is created utilizing any one of a number of methods that are well known to those of ordinary skill in the art, which database is keyed on Host Names that provide an entry point for a series of data (i.e., a roadmap) used by the application to carry out each step of each transaction. In addition, in accordance with one or more such embodiments of the present invention, a user can modify a transaction by adding or deleting steps used to carry out a particular transaction. In further addition, in accordance with one or more such embodiments of the present invention, the user may specify thresholds that trigger alerts to provide, for example and without limitation, real time indications, whenever, for example and without limitation, (a) there is a failure in carrying out one or more steps in a transaction sequence by, for example and without limitation, failing to access or download a page; or (b) the response time to carry out one or more steps in a transaction sequence exceeds a predetermined or user entered limit. Advantageously, (a) by enabling a user to set thresholds and (b) by sending alerts for exceeding such thresholds (for example and without limitation, on end-to-end response time and/or response time of a transaction's important steps), the application helps prevent serious problems from arising (a) by helping to indicate a probable trouble source, and (b) by limiting the effort involved in trouble shooting. Lastly, in accordance with one or more embodiments of the present invention, response times and other data (to be described in detail below) obtained during a particular transaction are stored in the Results database so that they may be examined to provide, for example and without limitation, historical analysis of changes in response times and failures over time. Advantageously, such historical analyses provide diagnostic value by showing how key performance indicators can be used to manage network performance. For example and without limitation, such analysis and reporting features allow tracking of trends, showing the level of success achieved by adjustments to a web site and/or a network, and providing higher levels of management with understandable reports relating to performance.

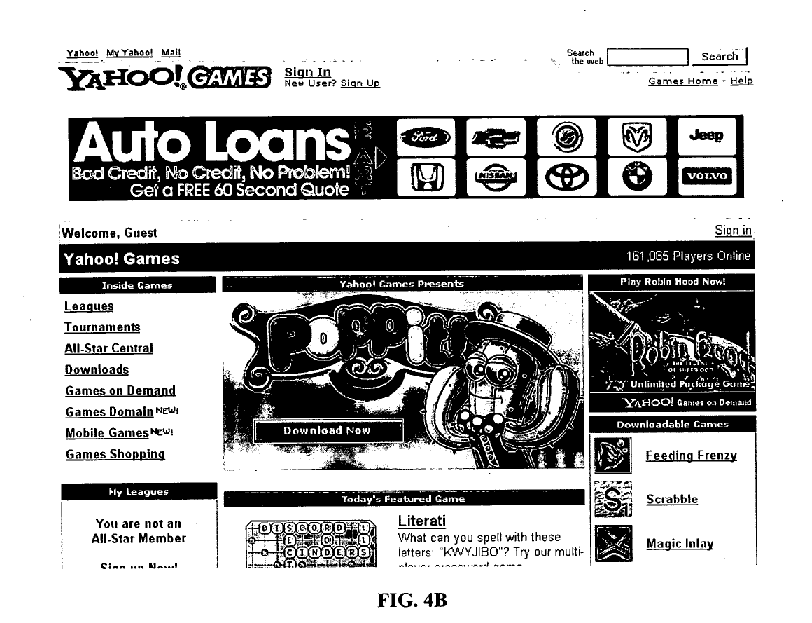

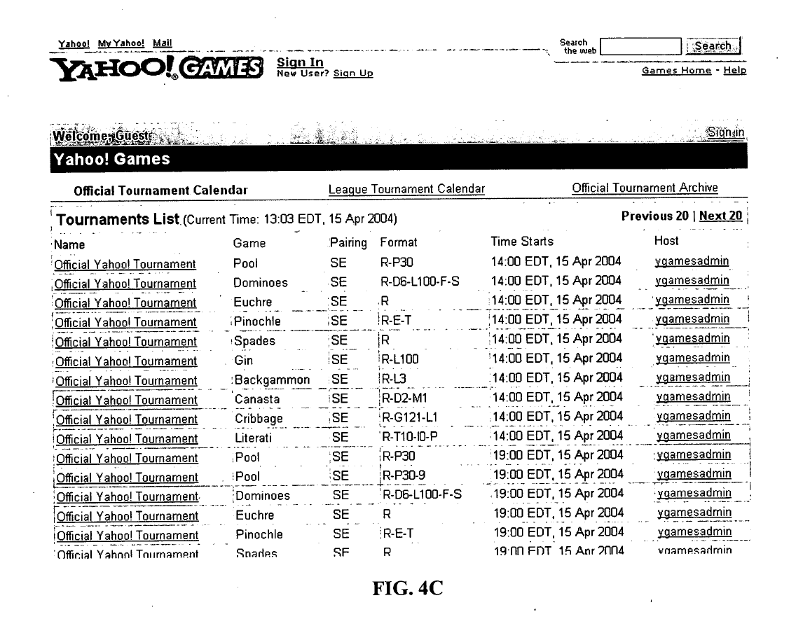

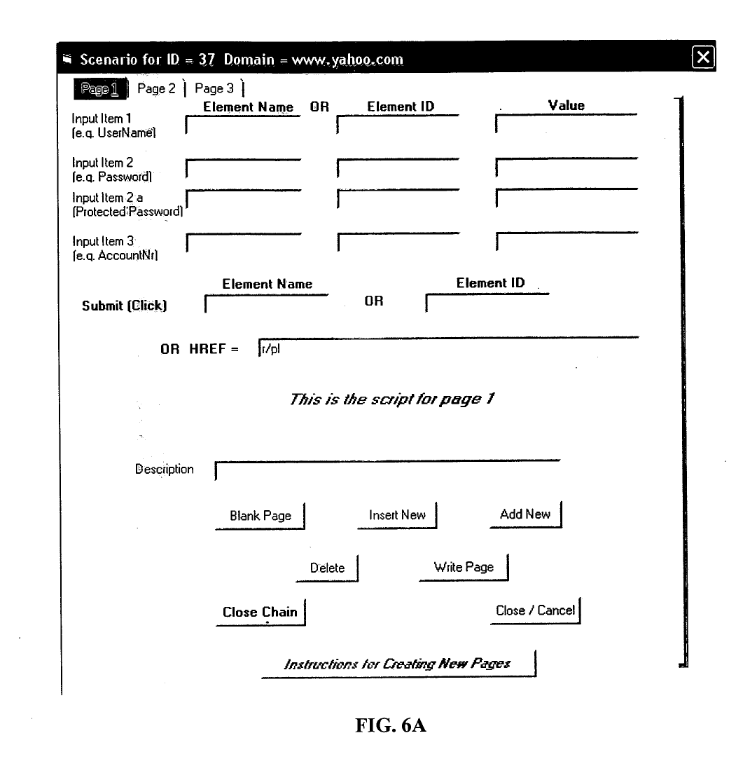

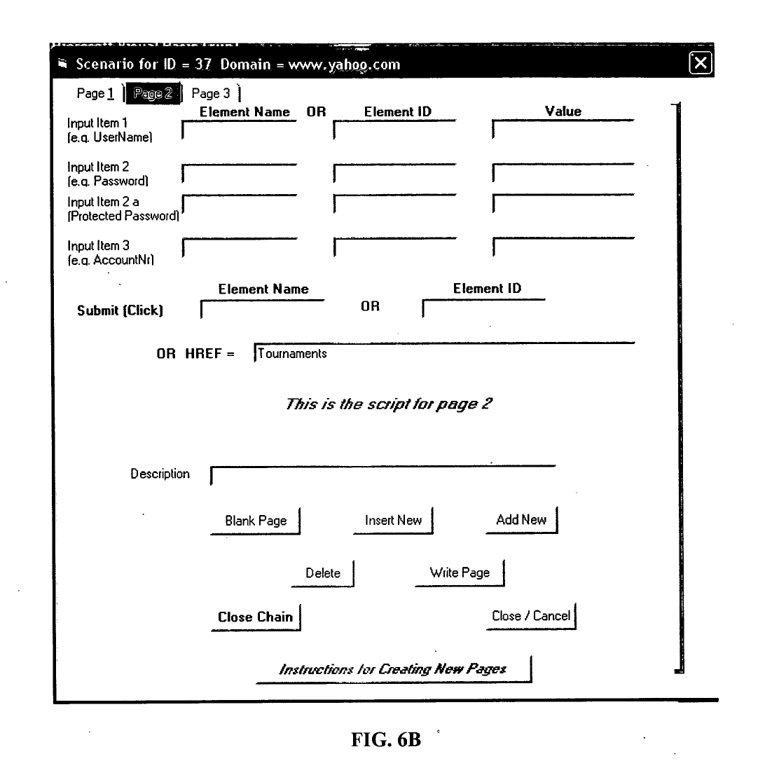

In accordance with one or more embodiments of the present invention, a user configures a Transaction database of transactions wherein each transaction is developed by filling out scripting pages in accordance with any one of a number of methods that are well known to those of ordinary skill in the art. To understand how this works, let us assume that a user wishes to have measurements for a transaction that corresponds to reaching a page accessed through a main or home page of Yahoo (“Yahoo home page”). FIG. 4A shows a representation of the Yahoo home page; FIG. 4B shows a page that is downloaded after clicking a “Games” link on the Yahoo home page; and FIG. 4C shows a page that is downloaded after clicking a “Tournaments” link on the Games page. FIG. 6A shows a scripting page used to enter information for configuring one step of this network transaction (i.e., to identify an appropriate element to click on the Yahoo home page to cause a download of the Games page); and FIG. 6B shows a scripting page used to enter information for configuring a subsequent step of this network transaction (i.e., to identify an appropriate element to click on the “Games” page to cause a download of the Tournaments page). As those of ordinary skill in the art will readily appreciate, the information entered by a user in the scripting pages shown in FIGS. 6A and 6B is used in accordance with any one of a number of methods that are well known to those of ordinary skill in the art to produce a database entry in the Transaction database that will be used in the manner described below to carry out the network transaction (i.e., downloading the Yahoo pages in the sequence shown in FIGS. 4A to 4C) and to measure the response times, including the end-to-end response time for this network transaction.

In accordance with one or more embodiments of the present invention, the Transaction database may be accessed using a Host Name, for example, www.yahoo.com, as an access key. In accordance with one or more such embodiments, the Host Name is a unique name that identifies a computer on a network. The user may enter a Webpage or URL for a Host Name, for example and without limitation, where the URL differs therefrom (for example, in one case a Host Name is www.citibank.com and the URL is /us/cards/index.htm). The Webpage or URL is a Web page address for the Host Name. In addition, the user may also enter a port number for the Webpage—for example, a default port number of 80 may be used for HTTP. In further addition, the user may enter a “Response Time” threshold. This threshold is a maximum acceptable response time. If this threshold is exceeded, an alarm or alert is sent, for example and without limitation, to the computer so that a user can perceive it. In still further addition, the user may enter a “Fail Rate” threshold. This threshold is a maximum acceptable fail rate percent per transaction. If this is threshold exceeded, an alarm or alert is sent, for example and without limitation, to the computer so that the user can perceive it.

It is often desirable to measure response times for a network transaction that involves accessing several pages, filling in values, and submitting requests. Such a network transaction is a sequence in which related pages are accessed (which access possibly includes emulation of user interactions). Setting up such network transactions requires scripting a transaction using scripting pages such as those shown in FIGS. 6A and 6B. As shown in FIG. 6A, the scripting page is labeled “Scenario for ID=37 Domain www.yahoo.com.” This indicates the first URL used to initiate the interactive transaction having ID=37 (ID=37 was set by a Transaction database input routine to indicate that this is the 37^{th} record in the Transaction database). The line in FIG. 6A labeled “Input Item 1 (for example, a UserName)” is utilized to enable a user to enter either an Element Name (a unique user name assigned by the user) or an Element ID (a unique ID assigned by the user) and a Value (the actual content of the input). For example, the Value for an Element Name “username” might be “John Smith.” The line in FIG. 6A labeled “Input Item 2 (e.g. Password)” is utilized to enable a user to enter further data that might be required for carrying out this step of the transaction. The line in FIG. 6A labeled “Input Item 2a (Protected Password)” is utilized to enable a user to enter still further data that might be required for carrying out this step of the transaction. Next, the line in FIG. 6A labeled “Input Item 3 (e.g. AccountNr)” is utilized to enable a user to enter yet still further data that might be required for carrying out this step of the transaction. As one can readily appreciate, such data (i.e., Input Items 1, 2 and 3) may be used, for example and without limitation, to fill out information required on, for example, a Home Page to permit entry into a web site. Next, the field in FIG. 6A labeled “Submit (Click)” is utilized to enable a user to enter either an “Element Name” or an “Element ID” of an Input type (i.e., corresponds to, for example and without limitation, a “button,” an “image,” an “area,” or any item that may have the “onclick” event). The field labeled “OR HREF” indicates text located within the anchor (A element) to identify it such as, for example and without limitation, the URL in the HREF or the text displayed for the link or unique parts of those. For the example shown in FIG. 6A, r/p1 is the URL to be found uniquely in the required anchor element. Lastly, the comment field labeled “Description” may be used to describe changes made to this scripting page.

Next, the scripting page shown in FIG. 6B has similar information to fill in for the next step of the transaction. Note that for the example shown in FIG. 6B, the field “OR HREF” has been given the data “Tournaments” to enable the anchor on the Games page to be identified.

Lastly, as shown in FIGS. 6A and 6B, “user input buttons” include “Blank Page”; “Insert New”; “Add New”; “Delete”; “Write Page”; “Close Chain”; and “Close/Cancel” which may be used in a manner which will be readily understood by one of ordinary skill in the art to perform database functions to enable a user to create a transaction by updating a sequence of transaction steps. When updating is complete, the transaction is stored in the Transaction database using any one of a number of methods that are well known to those of ordinary skill in the art to provide data that can be retrieved to carry out network transactions in the manner described herein.

As is well known to those of ordinary skill in the art, a Web page is a block of text that contains “content” and embedded control indicators which instruct an interpreter, for example and without limitation, a browser, how to treat the content. As is also well known, for HTML, controls are marked off from content and usually consist of a pair of brackets surrounding affected content with a left bracket being <control> and a right bracket being </control>. These controls are called elements and their representations are called tags (some tags do not require a right bracket, but those that do are called block elements). As is also well known, elements may have other elements included within their scope, and in fact, usually there are several levels of bracketing. The entire document is bracketed with <html> and </html>. What a user sees is typically bracketed within <body> and </body> brackets. Before the body there usually is a <head> </head> pair of brackets which contains “invisible” information about the whole document, and within that pair of brackets there may be a <script> and </script> pair of brackets which contains program-like coding, usually in Javascript. Thus, as is well known, a rudimentary document layout is: <html> <head> metatags, etc. <script> script coding </script> </head> <body> other tags that control what you see </body> </html>. This is the most rudimentary layout, and there are many optional variations that make the whole scheme much more complex. For example and without limitation, script may be interspersed between other elements in the body.

As is also well known, elements have properties, events and methods just like objects (and in fact, they are objects to the browser). The properties are things such as, for example and without limitation, name, id, and type (referring back to the input required to providing a scripting page for a transaction). The events are things such as, for example and without limitation, onclick and onmouseover. Lastly, the methods are things such as, for example and without limitation, post or get.

The elements of most interest for users of embodiments of the present invention because of the network transaction scripting requirements discussed above are input and anchor. The following simple example provides a form named “login.” It will send the values in the inputs shown using a method called “post” by means of secured http to a page that handles login submissions. There are two standard textbox input fields. The first is assigned the name “username” and the second is assigned the name “password.” Each of them also has an id. The difference between “id” and “name” is that “id” must be unique over the range of the whole document while “name” might reappear elsewhere in the document, for example, in some other form or table. “Value” will contain whatever the user enters in the textbox. “Password” has the type “password” which means that when the user enters his/her password it will appear as a string of asterisks. The third input is of type “submit” which means it has a built-in event handler for the “onclick” event which will submit the other inputs to the URL specified in the form's “action.” It will appear on the screen as a button with the words “Submit My ID” on its face. Notice that “input” is not a block element and so requires no right bracket. The entire string between <and > is a control. If the page designer wanted to perform some validating or other processing before sending the name and password, he/she might have had the last input look something like this: <input name=“doit” type=“button” value=“Submit My ID” onclick=“checkitout”> where “checkitout” is the name of a script routine, most likely in the head section, which ends with the command “submit.”

<form name=″login″ method=″post″ action=″https://to a processing
URL″>
<input name=”username” id=”moniker” value=””>
<input name=”password” id=”entrykey” type=”password” value=””>
<input name=”doit” type=”submit” value=”Submit My ID”>
</form>

As is well known, an anchor is a common method for simply showing a link that the user may click on: <a href=“the URL to go to”> Click here to get something </a> The phrase “Click here to get something” will appear on the screen, usually in blue, underlined type. If the user clicks on the phrase, the page at “the URL to go to” will be downloaded. One last element of interest is an image used as a clickable link mechanism which may be coded as:

<img src=“local or remote domain/picname.gif or jpg” onclick=“some
action or URL”>.

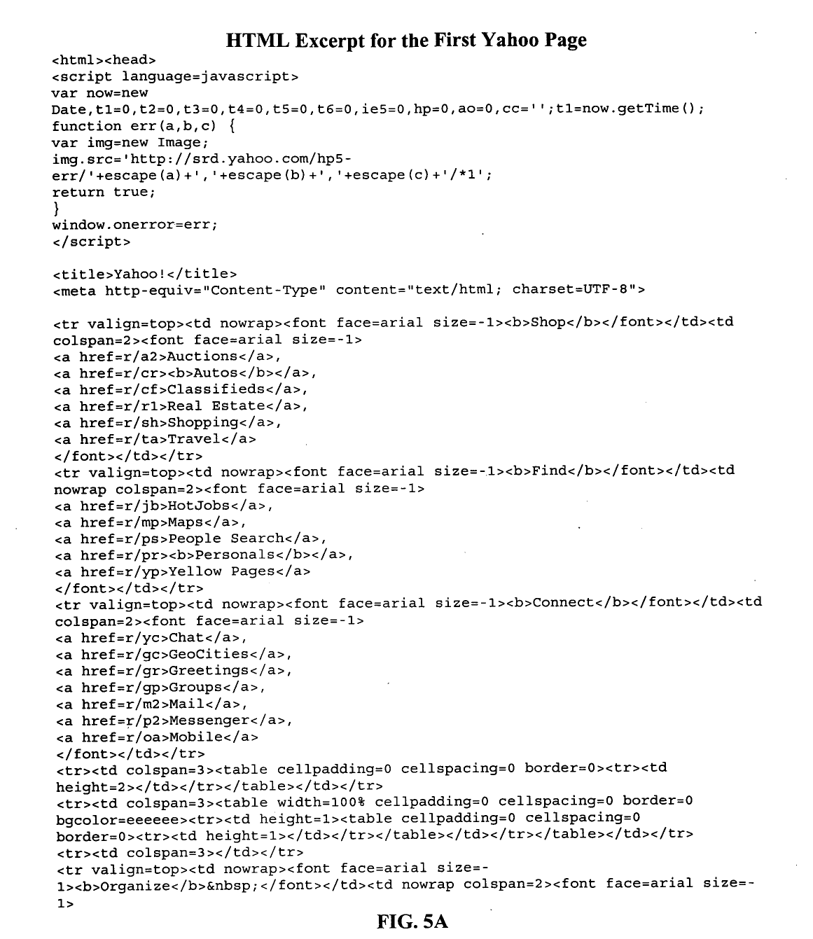

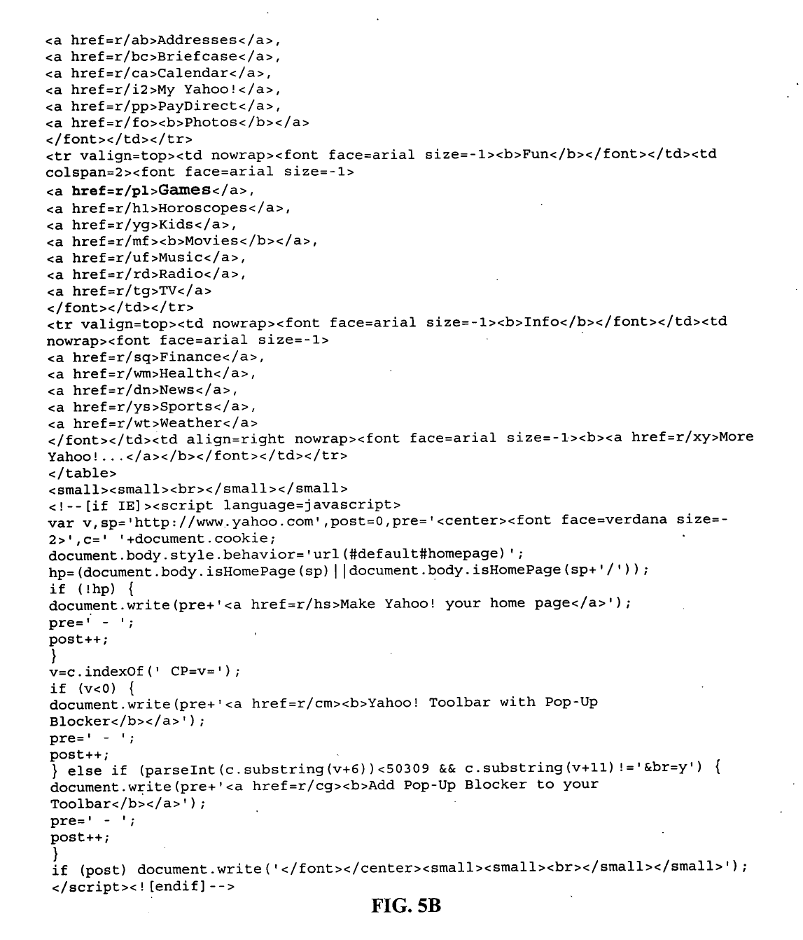

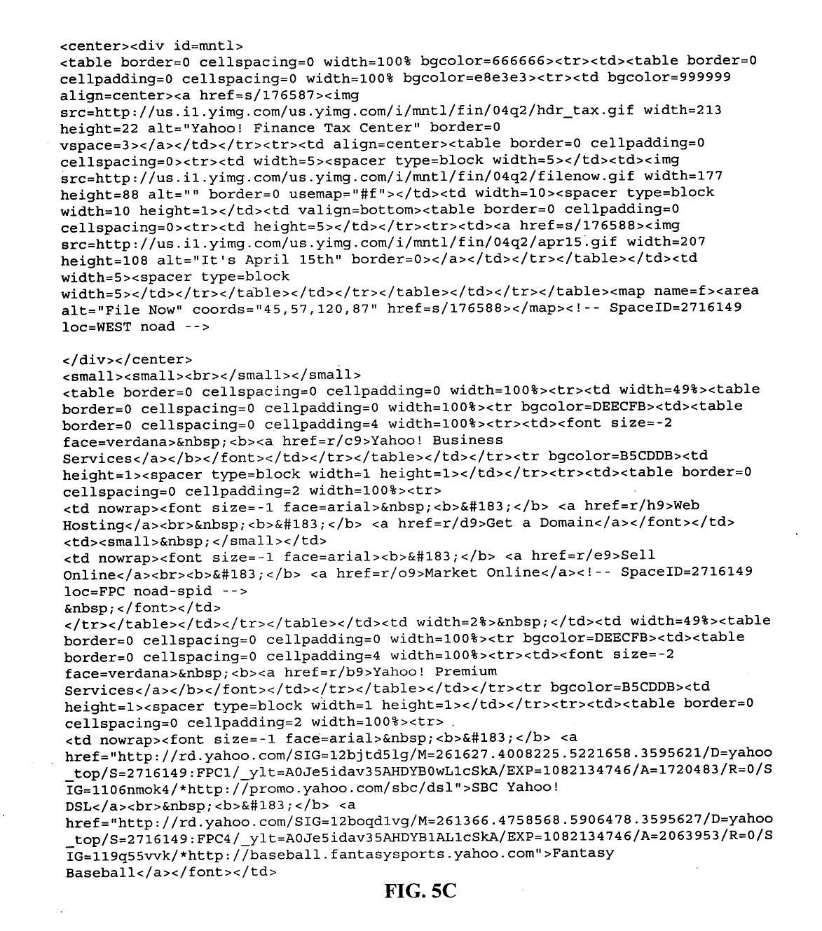

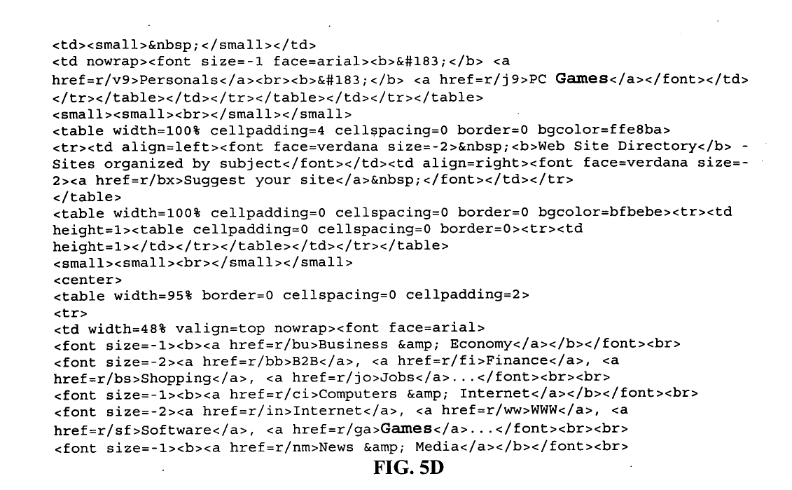

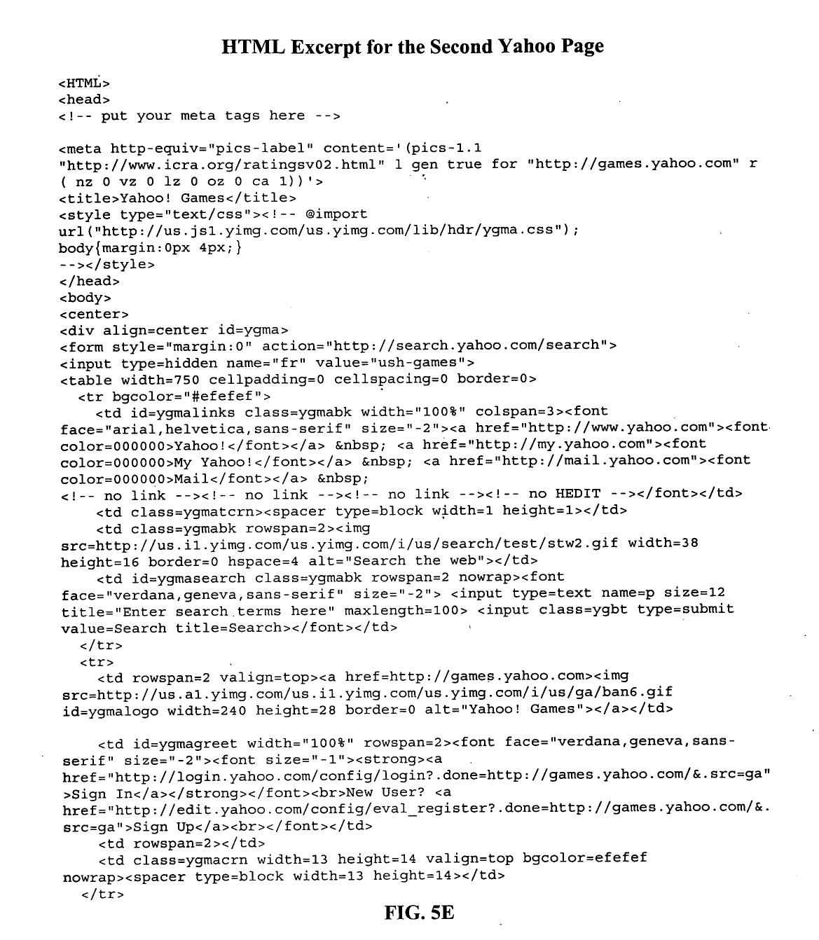

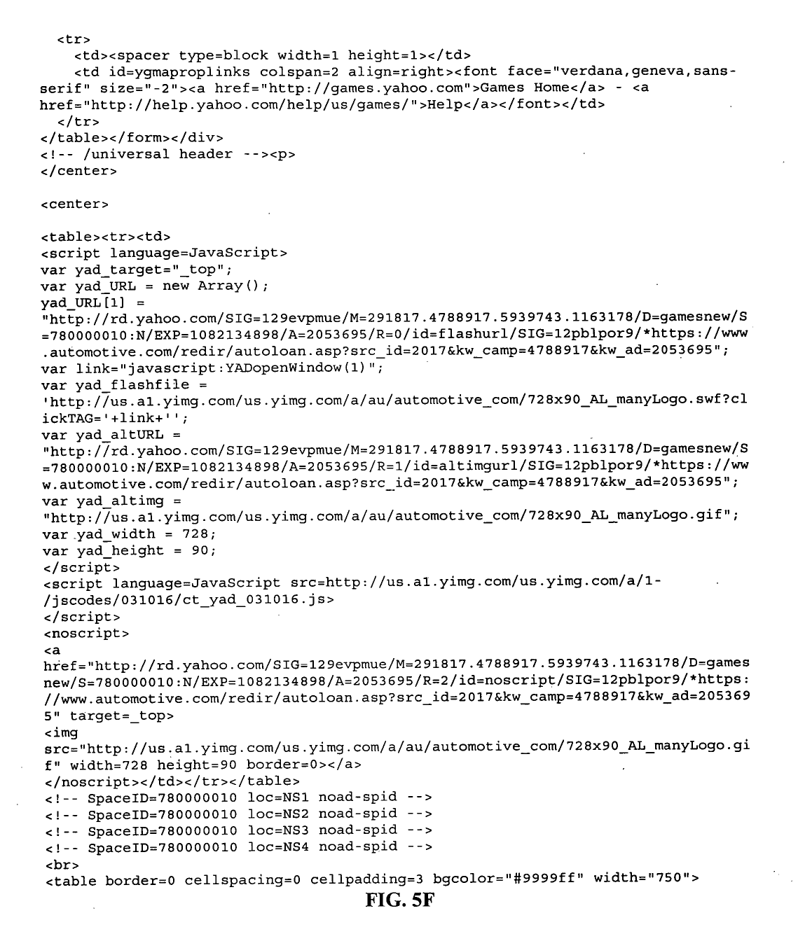

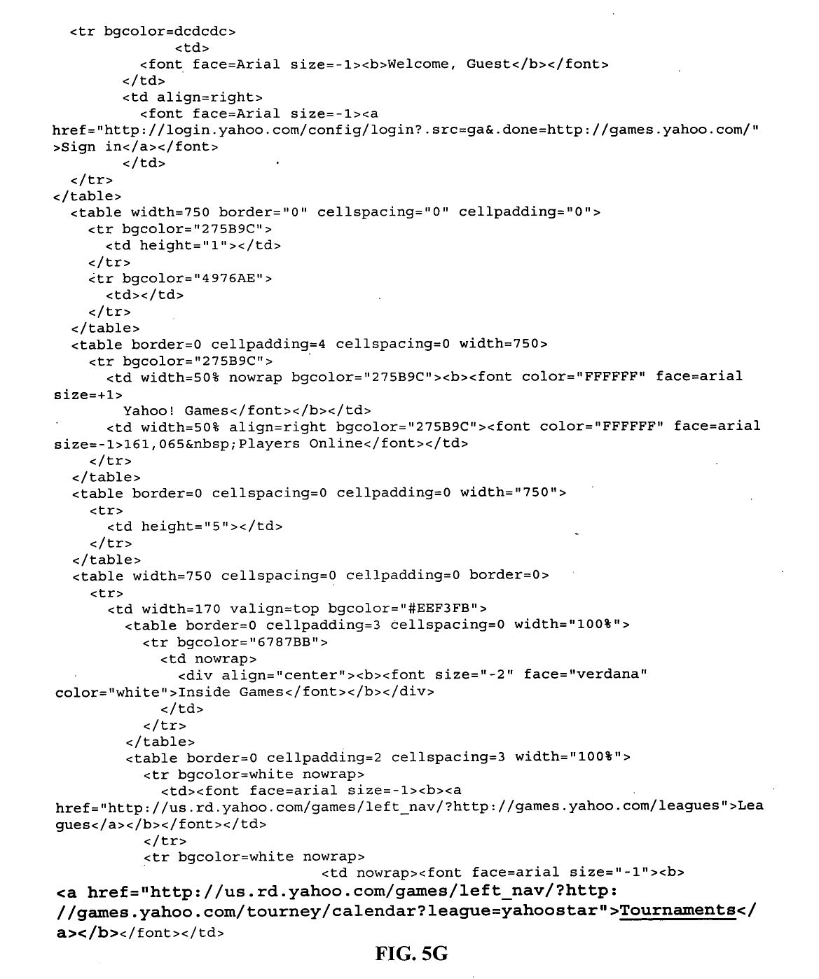

With the description above relating to scripting pages for creating a transaction and the description above relating to HTML, refer now to FIGS. 5A-5G. FIGS. 5A-5D and 5E-G show two excerpts of HTML text for the Yahoo home page shown in FIG. 4A and the Games page shown in FIG. 4B, respectively. Note that the HTML text shown in FIGS. 5A-5D contains three occurrences of “Games” as display text (which display text appears on the downloaded main Yahoo page) within anchor elements (<a . . . /a>) each of which anchor elements has a different HTML Reference (href= . . . ) or link. On the other hand, the HTML text shown in FIGS. 5E-5G contains only one occurrence of “Tournaments” as display text (which display text appears on the Games Yahoo page).

Thus, as one can now readily appreciate from the above, FIG. 6A is a script or transaction step to apply to the Yahoo main page shown in FIG. 4A. If there were values to be entered into text boxes, such as a user name and a password or a keyword for a search engine, they would be provided along with the name or ID of the HTML element in the document. In accordance with one or more embodiments of the present invention, in order to determine how to carry out the desired transaction step (and as will described in more detail below), the application searches the Input collection of a Document Object of a downloaded document (as is well known to those of ordinary skill in the art, the browser creates the Document Object using the downloaded document as input) for the names or IDs specified in the script for that transaction step, and it inserts the values provided in the script in the Value property (value=“ . . . ”) of the input element. If a Submit item is specified in the script (i.e., a button, an image, an area, an input, or any item that may have the “onsubmit” property), the applications searches the Document Object by name or Id, and applies the DHTML method “Click” to it.

In the example at hand (referring to the transaction of reaching the Tournaments page from the Yahoo home page), the URL for the next page (i.e., the next step of the transaction) is provided via a link, i.e., an anchor element. In accordance with one or more embodiments of the present invention, the application will find the anchor element using any related value given in the “HREF=” textbox of the script such as, for example and without limitation, the display text or any distinct portion of the URL itself. Since the Yahoo home page has a number of links containing the display text “Games” (see FIGS. 5A-5D), it would be ambiguous to use the display text as an identifier because several first anchor elements contain “Games.” Therefore, in such a case, the value of the HREF property of the desired anchor element should be used.

Further, because the display text on the Games page for the link to the Tournaments page is unique (see FIG. 5G) it is sufficient to provide only the display text for the “HREF=” field in the script shown in FIG. 6B.

As those of ordinary skill in the art can readily appreciate, input for a number of interactive transactions may be received and added to the Transaction database. In addition, the user may make any set thereof “active” (i.e., a set of transactions whose response times are to be determined by the application) in accordance with any one of a number of methods that are well known to those of ordinary skill in the art such as, for example and without limitation, with a mouse click. In further addition, and as was described above, each transaction may be associated with a set of thresholds and a sequence of steps consequent on performing scripted actions. For example and without limitation, in accordance with one or more embodiments of the present invention, the thresholds may be set for exceeding an overall response time set by the user, or, similarly, for exceeding a navigate time (to be described in detail below), or an overall wait time (to be described in detail below) or a navigate wait time. Lastly, the set of active transactions may be executed cyclically, may be executed any predetermined number of times, or may be executed for a predetermined period of time.

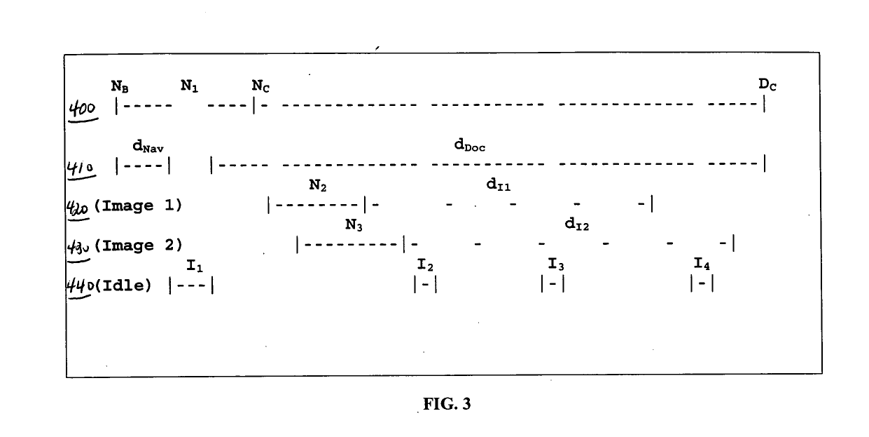

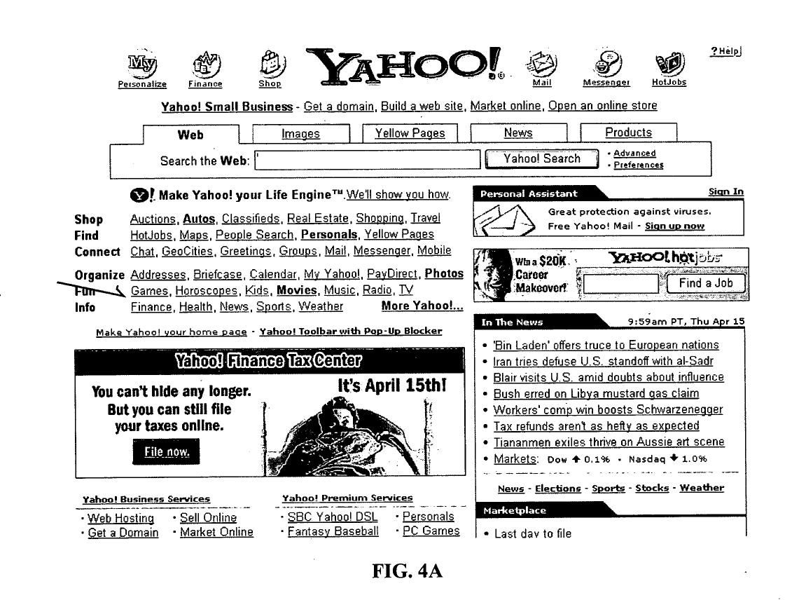

Before describing how an application that is fabricated in accordance with one or more embodiments of the present invention operates, a sample transaction will be described in conjunction with FIG. 3 that identifies components involved in transaction time measurement in accordance with one or more embodiments of the present invention. This will enable one to understand such embodiments more easily. As shown in FIG. 3, line 400 shows the cumulative activity for a page or document download. N_{B} on line 400 denotes a Navigate Begin for the document (Navigation Begin is a signal from the browser when the browser initiates a navigate command); N_{C} on line 400 denotes a Navigate Complete for the document (Navigation Complete is a signal from the browser that a navigate request has been satisfied); D_{C}=on line 400 denotes a Document Complete for the document (Document Complete is a signal from the browser that the entire document and all its included downloads are done); and N₁ denotes the Navigate Time for the document. As one can appreciate from line 400 of FIG. 3, the navigation has a period of waiting in the middle (this period of waiting is probably due to either server or network delays).

As further shown in FIG. 3, line 410 shows the cumulative download for a page or document download. d_{Nav} on line 410 denotes a Navigation Download for the document; and d_{Doc} on line 410 denotes a Document Download for the document. Note that the document download, i.e., the second download, starts before the main Navigate Complete is received (this occurs fairly often).

As further shown in FIG. 3, lines 420 and 430 show cumulative downloads for Image 1 and Image 2 of the document. N₂ on line 420 denotes the Navigate Time for Image 1; d_{I1} denotes the Download Time for Image 1; N₃ on line 430 denotes the Navigate Time for Image 2; and d_{I2} denotes the Download Time for Image 2. Note that the navigations for Images 1 and 2 are “overlapped” but not truly concurrent since there is only a single channel transferring the data.

As further shown in FIG. 3, line 440 shows the idle times for the browser. Note that when the browser is idle, all ongoing activities are idle together, however, the total idle time experienced by the various activities is not the same. In accordance with one or more embodiments of the present invention, the embodiment keeps track of all of the individual and total download and idle times and, as will be described below, reports on them separately.

With the above in mind, the following times are determined by the application:
Response Time=D_{C}−N_{B}

As such, Response Time is the time from the first Navigation Begin until the last Document Complete. For example, if the Response Time is given as 33934 ms, this means it took 33.934 seconds to complete a download from the beginning of navigation to the completion of the last file download. Note that in the case of an appended pop-up window, the last Document Complete may be later than that of the main page.
Navigate Time=N₁+N₂+N₃

As such, Navigation (or Network) Time is the full elapsed time from the start of a navigation until the navigation complete event is signaled. It includes forwarding from the requested page to one actually delivered (i.e., Redirect where Redirect means responding with a different URL from that requested without an apparent intervening download). For example, if the total Navigation Time is given as 8310 ms, this means that it took 8.31 seconds to complete the navigation. If the page redirects to another URL, then a second navigation occurs “seamlessly” and its time is part of the overall navigation time. The measure of Navigate Time is a sum of all navigates that occur within the page download (including navigates for remote image files, for instance).
Download Time=Downloadpage+d_{I1}+d_{I2}
where Download_{Page}=d_{Nav}+d_{Doc}

As such, Download Time is the time required to send any image or sound files, as well as the main HTML document and scripting. For example, if the Download Time is given as 21834 ms, this means it took a total of 21.834 seconds to complete the various download operations. Download Time is the sum of the times between each Download Begin and its Download Complete. This includes some time for a download that occurs within the navigation. The more complex a page is, i.e., the more graphics and other inclusions in the page, the longer the Download Time. If several large downloads are started together, then there may be interleaving of their segment deliveries (interleaving occurs when several downloads are started together, and since transmission to the browser is serial, their segments will be delivered in an interspersed manner) and the measures of their individual Download Times are increased by the time of the others' interspersed segment downloads. The ratio of the Download Time to Response Time minus Wait Time provides a rough index of how much such parallelism there is.
Wait Time=I₁+I₂+I₃+I₄

As such, Wait Time is the total of all periods during a transaction when the browser was idle. For example, if the Wait Time is given as 9308 ms, this means that within the response time, the browser has no activity for 9.3 seconds. No activity means that the browser is not navigating and it is not downloading, i.e., it is waiting for a server to respond. The delay could be caused by any of the servers involved or by components of the network. Wait Time may be improved through server tuning.

As one can readily appreciate from the description set forth above, in general, network delivery will affect Navigate Time and Download Time. As such, examination of network end-to-end response time and routing performance may be needed to improve network performance. In addition, in general, a server's capacity to process requests will affect Wait Time. As such, an examination of server CPU and I/O efficiency helps turnaround within the server which, in turn, reduces Wait Time.

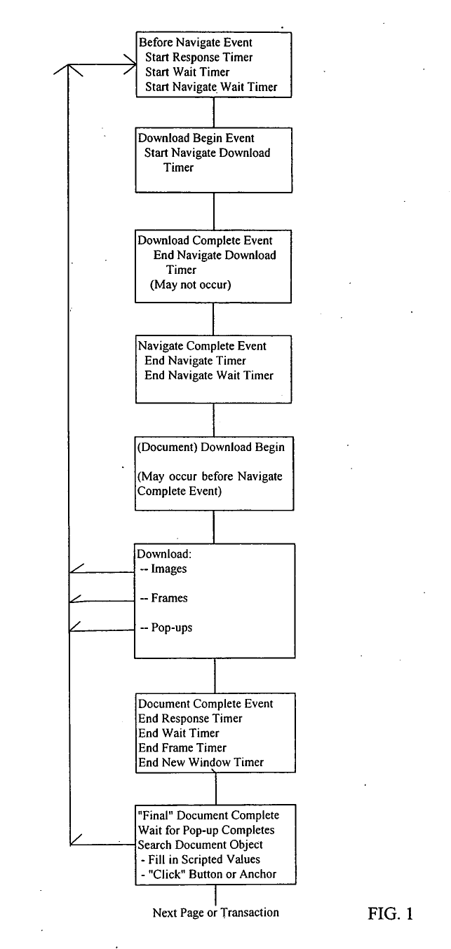

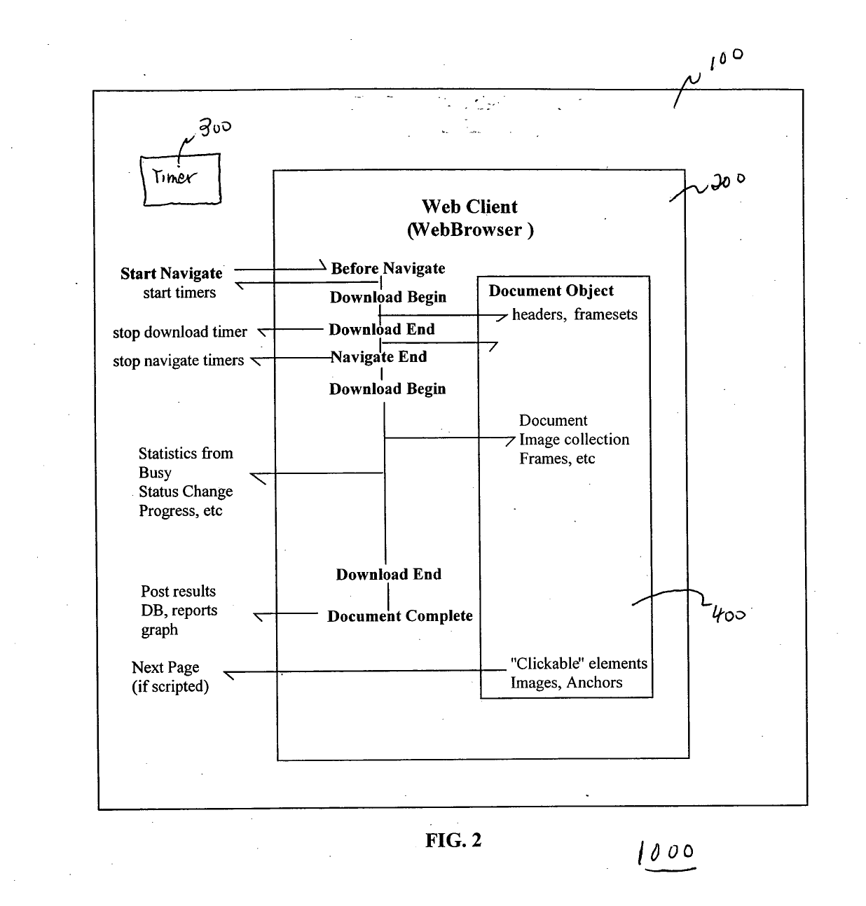

FIG. 1 shows a sequence of events and actions that take place as a transaction step is carried out (for example, as a page is downloaded from the Internet) by an application that is fabricated in accordance with one or more embodiments of the present invention. FIG. 2 shows, in block diagram form, components of an application that is fabricated in accordance with one or more embodiments of the present invention, and how the components exchange data and control in downloading a page from the Internet and measuring response times.

As shown in FIG. 2, application 1000 includes: (a) control application 100; (b) browser 200 such as, for example and without limitation, the Microsoft WebBrowser; and (c) high resolution timer 300 (for example and without limitation, a 2 ms timer which is available from Mabry Software, Inc. of Stanwood, Wash.) to measure in fine detail all of the contributions to end-to-end response in the manner to be described below. In accordance with one or more embodiments of the present invention, such contributions include, for example, and without limitation, all navigations and downloads that occur within other navigations and downloads, and the times when browser 200 sits idle waiting for external systems to provide it with data—the response times and wait times for each of the subcomponents of a transaction are separately recorded and reported. In addition, in accordance with one or more further embodiments of the present invention, file names, sizes of images and included HTML documents are captured, recorded, and reported. In further addition, Document Object 400 shown in FIG. 2 is generated by browser 200 as a document is being downloaded from the Internet. As shown in FIG. 2, Document Object 400 includes: (a) headers, frames set documents in a page with frames, and so forth; (b) a Document Image collection (with an image collection count), a Document Frame collection (with a frames collection count), and so forth; and (c) a list of “clickable elements. In the embodiment described below, browser 200 is the WebBrowser control which is the core of Internet Explorer and Document Object 400 is the Document Object associated with the WebBrowser Control.

In accordance with one or more such embodiments of the present invention, the properties, events and methods of the WebBrowser are used to track the sequence of events and the times involved therewith. Further, Document Object 400 provides a mechanism for examining the HTML elements and for managing the behavior of downloaded pages in the same manner as the page creator does with DHTML scripting with Javascript or Visual Basic Script (“VBS”) or the like. Note that, in accordance with one or more embodiments of the present invention, application 1000 is event driven, and that once an initial navigate is started there is no predictable sequence to events that arise from secondary navigations to retrieve images, frames and/or new windows (pop-ups). As such, an important task of control application 100 of application 1000 is to relate randomly occurring events and time measurements associated therewith to the proper navigation.

Embodiments of the present invention can be implemented on a variety of hardware and software platforms such as, for example, and without limitation, mainframes and PC workstations, Z-OS (or the like), Windows, Mac-OS, and all the varieties of Unix (Linux, Solaris, and so forth) and any applicable browsers such as Internet Explorer, Netscape and AOL, Opera, Mozilla, and so forth.

To begin, control application 100 obtains the URL of an initial destination for a particular transaction to be monitored. As will described below, control application 100 reacts to major events signaled by browser 200, and reacts to interrupts from timer 300.

As shown in FIG. 2, control application 100 executes a Navigate2 command of browser 200 with the URL of the initial destination. Shortly after that (typically, a matter of microseconds), as shown in FIGS. 1 and 2, browser 200 fires a BeforeNavigate event.

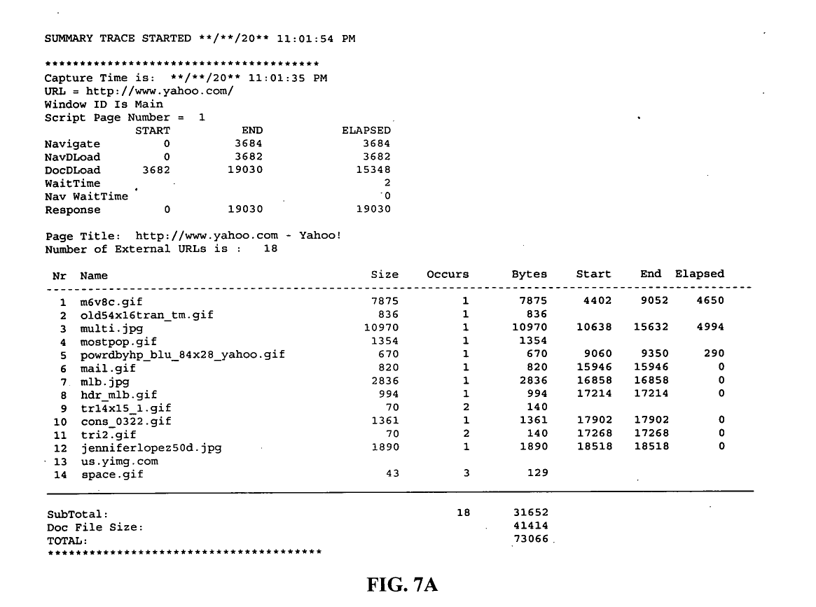

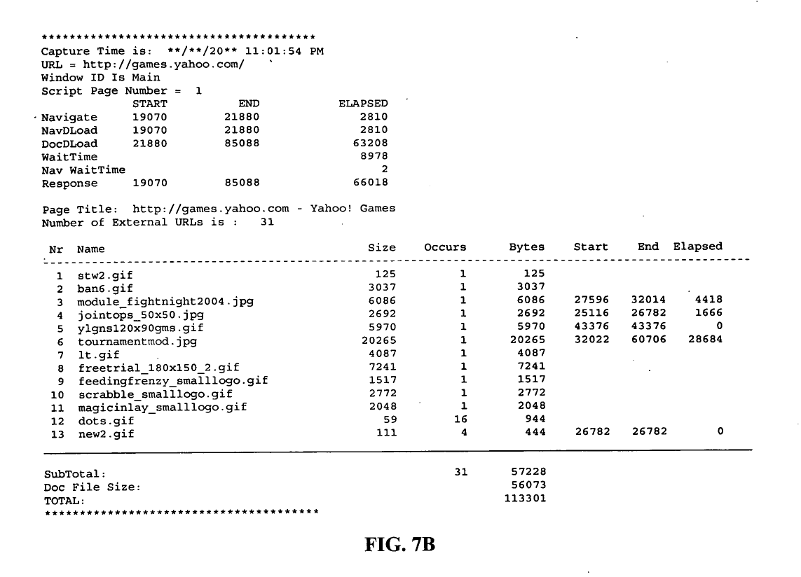

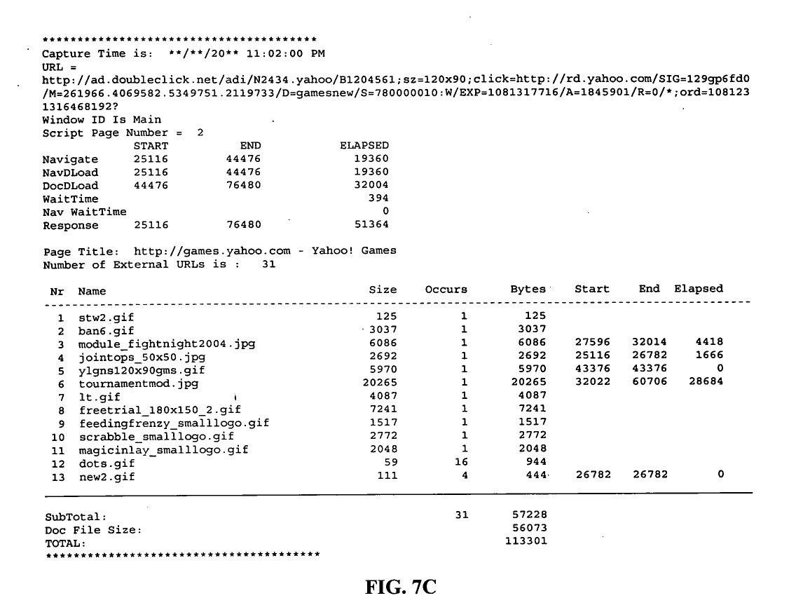

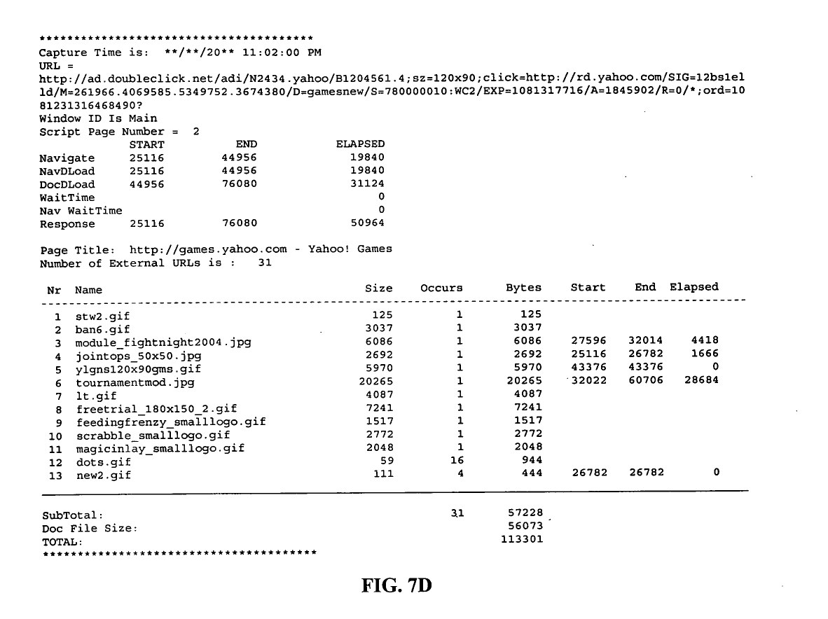

As shown in FIGS. 1 and 2, in response to the BeforeNavigate event received from browser 200, control application: (a) creates a History Record, and adds it to an array of History Records in the Results database (as will described in detail below, the contents of the History Record may be published as a Summary Trace shown in FIGS. 7A-7D) in accordance with any one of a number of methods that are well known to those of ordinary skill in the art; (b) sets a Capture Time (i.e., time of day clock) in accordance with any one of a number of methods that are well known to those of ordinary skill in the art; (c) starts timers for Response Time, Wait Time, and Navigate Wait Time by resetting them to zero; (d) sets a URL and Frame Name (null if not a frame); and (e) sets a pointer for the current download to the new History Record.

Next, as shown in FIGS. 1 and 2, a few milliseconds later, browser 200 fires a DownloadBegin event. In response to the DownloadBegin event, control application 100 determines whether the Navigate Download Begin timer has been started and posted for the current download, and if not, it does so (the time is obtained from timer 300 in accordance with any one of a number of methods that are well known to those of ordinary skill in the art).

Next, as shown in FIGS. 1 and 2, browser 200 fires a DownloadComplete event (this event is always present). In response to the DownloadComplete event, control application 100 determines whether the Navigation Download Begin timer has been posted (if not it posts it), and it posts the Navigation Download End time (the time is obtained from timer 300 in accordance with any one of a number of methods that are well known to those of ordinary skill in the art).

Next, as shown in FIG. 1, if the navigation occurs without error, browser 200 fires a NavigateComplete event (this event includes a URL); otherwise, the NavigateComplete event does not occur. In response to the NavigateComplete event, control application 100: (a) finds a History Record with the same URL as that of the NavigateComplete event; and (b) posts the Navigate End Time (the time is obtained from timer 300 in accordance with any one of a number of methods that are well known to those of ordinary skill in the art) and Navigate Wait Time. If, however, there is no History Record with the same URL as that of the NavigateComplete event, then it uses the Current History Record. Lastly, if a Navigation Download Begin Time has not been posted, then post it equal to the Navigation Begin Time. The NavigateComplete URL may not match the URL of the Navigate2 command, among other reasons, because of a redirect.

Next, as shown in FIGS. 1 and 2, a document DownloadBegin event is received, which DownloadBegin event signals commencement of the download of a HTML document—starting with required headers, a frameset document in a page with frames, and so forth. In response, control application 100 determines whether the Document Download Timer has been started and posted for the current download, and if not, it does so.

As is well known, browser 200 creates Document Object 400 as the document is downloaded, i.e., as it is received. In principle, Document Object 400 ought to be ready for use or at least ready for some uses after the DownloadBegin event is received. In practice however, immediate use of Document Object 400 would be risky since there is no assurance that the entire document has been downloaded and parsed (i.e., to form a complete version of Document Object 400) until browser 200 fires a DocumentComplete event.

Note that neither a DownloadBegin event nor a DownloadComplete event has any identifiers associated with them. As such, control application 100 must determine which events have started and completed in order to keep timing records for them. Up to this point that is not very difficult since there is, in effect, only a single thread of events. However, the document DownloadBegin event begins multithreaded downloads of images and other linked contents. As such, there may be several navigations going on at one time, and several file downloads as well.

In accordance with one or more embodiments of the present invention, control application 100 keeps track of all of the individual and total download and idle times and reports on them separately (see FIGS. 7A-7D). For example, when a pop-up is first received, browser 200 issues a NewWindow2 event. In response, control application 100 sets a New Window Timer. When a frame is first received, browser 200 issues a NewFrame event. In response, control application 100 sets a Frame Timer. More specifically, in response to a NewWindow2 event (i.e., a pop-up) control application 100 creates a whole new browser 200 and Document Object 400. Note that in doing so, all the variables, constants and so forth of the main browser 200 are recapitulated in the new browser 200. In addition, a string variable in the declarations is filled with the window ID (Main for the original and NewWindow concatenated with a New Window counter for the one just created since there may be several such New Windows).

In response to a StatusTextChange event fired by browser 200, control application 100 determines whether it corresponds to a DownLoadingPicture event. If so, control application 100: (a) captures the file ID and time stamps it; and (b) examines the Images collection in Document Object 400 and, using the file ID, captures its size for reporting (see FIGS. 7A-7D).

As shown in FIGS. 1 and 2, after a document is downloaded, a DownloadComplete event is fired by browser 200. However, there may be a number of DocumentComplete events received which result from other downloads initiated by the main page download. In response to a DocumentComplete event, control application 100 posts in the Results database information such as, for example and without limitation, the Response Timer, the Wait Timer, the Frame Timer, and the New Window Timer. In addition to such DownloadComplete events, there is a “final” DocumentComplete event which is distinguished from other DocumentComplete events by the fact that its “pDisp” parameter is a WebBrowser Object. However, the final DocumentComplete event may not be the last such event received “in time” because other events initiated by the main download may not yet have completed. Notable examples of such other events are pop-ups and frames opened in the main download with their own URLs and so on. To ensure an orderly tracking process, control application 100 keeps a count of all downloads by type so that it does not incorrectly conclude that the “final” DocumentComplete event is last in time. This means, that control application 100 does not declare that a transaction has been completed until it has received notification that all downloads have been completed. In practice, this is done by tracking the number of the types of events that have begun, and waiting until DocumentComplete events (the DocumentComplete event identifies the type of event to which it relates) have been received for all types expected (for example, the frames collection count may be used to track completion of all frames).

Specifically, in response to a DocumentComplete event, control application 100 checks to see whether it corresponds to a Frame or Frameset, and if so, it sets various end times accordingly, and reduces the frames collection count by one. Next, control application 100 determines whether “pDISP IS WEBBROWSER.OBJECT” (as described above, this identifies the “final” DocumentComplete event.

In response to determining that a transaction step is complete, control application 100 searches Document Object 400, and fills in scripted values, i.e., it “clicks” “clickable” elements such as, for example, a button, an image, an anchor, and so forth. Finally, timer 300 tests whether the flag Whole is set to done (see below) and that the status of browser 200 is not busy, and if so, it cycles to retrieve the next step in the transaction, if it exists.

If this is the “final” DocumentComplete event, control application 100: (a) determines whether this is a New Window (i.e., a pop-up), and if so, it: (i) reduces the NewWindow count by 1, (ii) stores the History Record in a New Windows collection (this is necessitated by the fact that the New Window is in another copy of browser 200 which must be closed right away), and (iii) closes the browser 200 copy window; (b) if this is the Main Window (i.e., not a New Window), it marks the Main Window as done; (c) if the Main Window is done and the New Window count is zero then it: (i) marks the Whole transaction step as done, (ii) prints a Summary Record if requested by user input, and (iii) prints any other records requested by the user such as, for example and without limitation, downloaded files.

In accordance with one or more embodiments of the present invention, timer 300 is used to obtain a time for use in setting the various Timers described above. In addition, in accordance with one or more embodiments of the present invention, control is periodically (for example and without limitation, every 2 ms) transferred to timer 300 (for example, on an interrupt basis). At such times, timer 300 obtains status information from browser 200. For example, if the status information indicates that browser 200 is idle, timer 300 updates relevant Wait Timers by 2 ms.

FIGS. 7A-7D show reports of response times of: (a) an entire transaction download; (b) each page downloaded; and (c) each interior download within each page download (from a different date and time). In particular, FIG. 7A shows a detailed report of the constituents of the main page download, all times are in milliseconds from 2 ms timer 300. In particular, FIG. 7A shows the time for the navigation, the download within the navigation (which download ends 2 ms earlier than the navigation), the document download (which document download includes the times to download all of the images), and the total Response Time. The list of pictures is produced (as was described above) by matching items in the images collection of Document Object 300 with filenames extracted from trapped and timestamped “status text” messages from browser 200. Where a status text shows a download end time, the elapsed time of the actual transmission can be calculated.

FIG. 7B shows the same report for the download of the Games page. FIGS. 7C and 7D show downloads of two advertisements from Doubleclick.net. Note that both of these downloads occur within the period of the main page download, and are concurrent with each other.

The data in the Result database may be utilized to analyze performance by reviewing transaction results relating to data on which measurements are made, hour in which Start Times for the measurements were made, day of the week during which measurements were made, and so forth. These data may be perceived in tabular form or in graphical form. In addition, one can determine information such as, for example and without limitation: (a) average Response Time (i.e., the average time elapsed from the first navigate begin to the last document complete); (b) average Download Time (i.e., the average time required to send any image or sound files as well as the main HTML and scripting); (c) average Navigate (or Network) Time (i.e., the average time elapsed from the start of a navigation is signaled, including forwarding from the requested page to the one actually delivered); (d) average Wait Time (i.e., the average time elapsed during which the browser was idle); (e) minimum and/or maximum Response Time; (f) minimum and/or maximum Download Time; (g) minimum and/or maximum Navigate (or Network) Time; and (h) minimum and/or maximum Wait Time.

Although various embodiments that incorporate the teachings of the present invention have been shown and described in detail herein, those skilled in the art can readily devise many other varied embodiments that still incorporate these teachings.

What is claimed is:

1. A method for measuring responses incurred in network transactions that include one or more transaction steps comprising:
identifying browser events and setting timers use to determine navigation times and document download times;
periodically testing browser status to determine browser idle times; and
determining end-to-end response times and response times for the one or more transaction steps from the navigation times, and document download times.

2. The method of claim 1 wherein determining browser idle times further comprises updating idle time counters to provide a measure of idle time for the one or more transaction steps.

3. The method of claim 2 wherein the step of identifying browser events further includes examining a Document Object created by the browser.

4. The method of claim 3 wherein the step of identifying browser events includes identifying one or more of a BeforeNavigate event, a NavigateComplete event, a DownloadBegin event, a DownloadComplete event, a New Window2 event, and a StatusTextChange event.

5. The method of claim 4 wherein the step of identifying browser events further includes identifying a final DocumentComplete event by the fact that its “pDisp” parameter is a WebBrowser Object.
